(19) United States
(12) Patent Application Publication
(10) Pub. No.: US 2023/0394986 A1
(43) Pub. Date: Dec. 7, 2023

(54) TEST QUESTION GENERATION METHOD, APPARATUS AND SYSTEM, AND COMPUTER STORAGE MEDIUM AND PROGRAM PRODUCT

(71) Applicants: Runyu HU, Guangzhou (CN); Chaowei WU, Foshan (CN)

(72) Inventor: Runyu HU, Guangzhou (CN)

(21) Appl. No.: 18/235,444

(22) Filed: Aug. 18, 2023

Related U.S. Application Data
(63) Continuation of application No. PCT/CN2022/076850, filed on Feb. 18, 2022.

(30) Foreign Application Priority Data
Feb. 20, 2021 (CN) 202110193645.1

(51) Int. Cl. G09B 7/00; G06F 16/2457

(52) U.S. Cl. CPC G09B 7/00; G06F 16/2457

(57) ABSTRACT

The disclosure relates to a method, an apparatus and a system for generating test question. The method for generating the test question includes the following steps: a preset condition receiving step for receiving preset condition; an initial element generating step for generating an initial element of a test question based on at least one preset database according to preset condition; an intermediate element generating step for generating an intermediate element of the test question based on the initial element of the test question and at least one preset database according to preset condition; a test question judging step for judging whether the test question composed of the initial element and the intermediate element meets the preset condition; and a test question generating step for generating the test question based on the initial element and the intermediate element.

### CROSS-REFERENCE TO RELATED APPLICATIONS

This application claims the priority to and benefits of International Patent Application No. PCT/CN2022/076850, filed on Feb. 18, 2022. For all purposes under the law, the entire disclosure of the aforementioned application is incorporated by reference as part of the disclosure of this application.

### BACKGROUND OF THE INVENTION

The present disclosure relates to the field of computer-aided teaching, and in particular relates to a test question generating method, a test question generating apparatus, a test question generating system, a using method of the test question generating system, an electronic device, a computer-readable storage medium and a computer program product.

In recent years, with the maturity of big data technology, various algorithms, related hardware computing power and intelligent terminal equipment, computer-aided teaching technology has been developed by spurt. Various intelligent teaching websites, applications and related equipment provide quantitative and intelligent auxiliary teaching services for both teaching parties. Intelligent question-setting service has always been a hot spot in computer-aided teaching service. Users hope to get the test questions for their weak knowledge points for training by using the relevant intelligent question-setting services of service providers.

At present, the existing question-setting service is mainly based on the existing question bank to generate questions and test papers. Specifically, the existing question-setting service is based on the content that needs to be examined, and the test questions or test papers composed of multiple test questions are selected from the existing question bank through the recommendation system and provided to users. However, because the question bank can only identify the knowledge points involved in each topic as a whole, and the topic itself may require multiple different problem-solving steps, and each problem-solving step may correspond to its own different specific knowledge points, the problem-setting service based on the question bank can't give questions for the knowledge points involved in the specific problem-solving steps, so it lacks sufficient pertinence. The question-setting service based on the question bank is limited by the question bank itself, and the questions it can give are only the existing questions in the question bank itself, which cannot meet the normative requirements of different examination forms for the questions. The question-setting service based on history question bank can't provide the latest time-sensitive questions at any time as required by the reform of teaching and assessment. In addition, the question-setting service lacks effective interaction with users who use the service, and it is often difficult for the question-setting service provider to identify the user's answer, and it is impossible to analyze the user's current answer and history record to provide more accurate question-setting service.

### SUMMARY OF THE INVENTION

The present disclosure has been made in view of the above problems. The invention provides a test question generating method, a test question generating apparatus, a test question generating system, a using method of the test question generating system, an electronic device, a computer-readable storage medium and a computer program product.

According to one aspect of the present disclosure, there is provided a test question generating method, which comprises a preset condition receiving step of receiving a preset condition; an initial element generating step of generating an initial element of a test question based on at least one preset database according to the preset condition; an intermediate element generating step of generating an intermediate element of a test question based on the initial element of the test question and the at least one preset database according to the preset condition; a test question judging step of judging whether a test question consisting of the initial element and the intermediate element of the test question meets the preset condition, returning to the initial element generating step or the intermediate element generating step when the test question does not meet the preset condition, and proceeding to the test question generating step when the test question meets the preset condition, wherein, one of the initial element of the test question and the intermediate element of the test question generated by the last execution of the intermediate element generating step of the test question is used for generating the answer of the test question, and the other of the two is used for generating the question of the test question.

In addition, the test question generating method according to an aspect of the present disclosure, wherein other test question intermediate elements except the test question intermediate element generated by the test question intermediate element generating step are corresponding to the test question answer step.

In addition, the test question generating method according to an aspect of the present disclosure, wherein the at least one preset database includes a knowledge base database, an examination information base, a user group pattern database, and a user history database.

In addition, according to an aspect of the present disclosure, the test question generating method, wherein the knowledge base database is used for storing information related to the knowledge to be examined, including one or more of basic knowledge information, common sense information, problem-solving thinking information, problem-solving method information and error-prone point information.

In addition, according to an aspect of the present disclosure, the test question generating method, wherein the test information base is used for storing information related to the test, including one or more of test paper structure information, question type information, difficulty distribution information, test time information and test style information.

In addition, according to an aspect of the present disclosure, the test question generating method, wherein the user group pattern database is used for storing information related to the user group, and the information related to the user group is obtained based on the usage records of the user group, including one or more of problem-solving speed information, error-prone knowledge information, problem-solving habit information and psychological acceptance limit information of a specific user group.

In addition, according to an aspect of the present disclosure, the test question generating method, wherein the user history database is used for storing information related to a specific user, including one or more of the answer history information, knowledge mastery information and learning progress information of the specific user.

In addition, the test question generating method according to an aspect of the present disclosure, wherein the preset condition includes one or more of a question type constraint condition, an examination content constraint condition and an examination style constraint condition.

In addition, the method for generating test questions according to an aspect of the present disclosure, wherein when the test questions meet the preset condition, generating the test questions based on the initial elements of the test questions and the intermediate elements of the test questions further comprises generating additional elements according to the question constraint conditions in the preset condition; and combining the initial element of the test question, the intermediate element of the test question and the additional element to generate the test question satisfying the constraint conditions of the test question.

In addition, the test question generating method according to an aspect of the present disclosure, wherein the test question initial element generating step comprises determining the test sites based on the knowledge base database, the user history database and/or the user group pattern database.

In addition, the test question generating method according to an aspect of the present disclosure, wherein the test question intermediate element generating step comprises: determining a problem-solving idea based on the test question initial element and the at least one preset database.

In addition, the test question generating method according to one aspect of the present disclosure further comprises a test question generating step of repeatedly executing the test question initial element generating step, the test question intermediate element generating step, the test question judging step and the test question generating step to generate a plurality of test questions; a test paper judging step of judging whether the multi-channel test questions meet the preset condition, returning to the test paper generating step when the multi-channel test questions do not meet the preset condition to regenerate one or more of the multi-channel test questions, and proceeding to the whole test paper generating step when the multi-channel test questions meet the preset condition to generate test papers based on the multi-channel test questions.

In addition, according to an aspect of the present disclosure, the test paper judging step comprises: generating a whole test paper constraint parameter based on the preset condition, wherein the whole test paper constraint parameter comprises one or more of a whole test paper question type parameter, a single question parameter of each test question, an associated parameter of each test question in the whole test paper, a generation time parameter, a maximum permissible error parameter and an answer time parameter; Judging whether the multiple test questions meet the constraint parameters of the whole test paper.

In addition, the method for generating test questions according to an aspect of the present disclosure, wherein when the multiple test questions do not meet the preset condition, returning to the test paper generating step to regenerate one or more of the multiple test questions comprises dynamically adjusting the whole test paper constraint parameters and returning to the test paper generating step to regenerate one or more of the multiple test questions.

Furthermore, the test question generating method according to an aspect of the present disclosure, wherein the generation error of one or more of the multiple test questions is less than a predetermined threshold.

In addition, the test question generating method according to an aspect of the present disclosure, wherein the test question initial element and the test question intermediate element respectively have corresponding first parameter range intervals, and the test question initial element and the test question intermediate element generated after returning to the test question initial element generating step respectively have corresponding second parameter range intervals, and the second parameter range intervals are smaller than the first parameter range intervals.

According to another aspect of the present disclosure, there is provided a test question generating apparatus, including a preset condition receiving unit configured to receive preset condition; an initial element generating unit configured to generate an initial element of the test question based on at least one preset database according to the preset condition; an intermediate element generating unit configured to generate an intermediate element of a test question based on the initial element of the test question and the at least one preset database according to the preset condition; a test question judging unit configured to judge whether a test question consisting of the initial element and the intermediate element of the test question meets the preset condition, and a test question generating unit configured to generate the test question based on the initial element and the intermediate element of the test question, wherein when the test question does not meet the preset condition, the initial element of the test question is returned to the test question generating unit to be regenerated, or the question intermediate element generating unit regenerates the question intermediate element, and when the question meets the preset condition, the question generating unit generates the question based on the question initial element and the question intermediate element, wherein one of the question initial element and the question intermediate element generated by the question intermediate element generating unit for the last time is used for generating the answer of the question, and the other of the two is used for generating the question of the question.

According to another aspect of that present disclosure, there is provided a method for generate test questions, including a preset condition receive step of receiving preset condition; generating test questions based on at least one preset database according to the preset condition; a test paper generating step of organizing a plurality of test questions to generate a test paper after repeatedly executing the test question generating step for a plurality of times to generate a plurality of test questions; a test paper judging step of judging whether the test paper meets the preset condition, returning to the test paper generating step or the test paper generating step when the test paper does not meet the preset condition, and outputting the test paper when the test paper meets the preset condition.

In addition, the test question generating method according to another aspect of the present disclosure, wherein the at least one preset database includes a knowledge base database, an examination information base, a user group pattern database, and a user history database.

In addition, according to another aspect of the present disclosure, the test question generating method, wherein the knowledge base database is used to store information related to the knowledge to be examined, including one or more of basic knowledge information, common sense information, problem-solving thinking information, problem-solving method information and error-prone point information.

In addition, according to another aspect of the present disclosure, the test question generating method, wherein the test information base is used for storing information related to the test, including one or more of test paper structure information, question type information, difficulty distribution information, test time information and test style information.

In addition, according to another aspect of the present disclosure, the test question generating method, wherein the user group pattern database is used for storing information related to the user group, and the information related to the user group is obtained based on the usage records of the user group, including one or more of problem-solving speed information, error-prone knowledge point information, problem-solving habit information and psychological acceptance limit information of a specific user group.

In addition, according to another aspect of the present disclosure, the test question generating method, wherein the user history database is used to store information related to a specific user, including one or more of the answer history information, knowledge mastery information and learning progress information of the specific user.

In addition, according to another aspect of the present disclosure, the test question generating method, wherein the preset condition includes one or more of a question type constraint condition, an examination content constraint condition and an examination style constraint condition.

In addition, according to another aspect of the present disclosure, the test question generating method comprises an initial element generation sub-step of generating an initial element of the test question based on at least one preset database according to the preset condition; an intermediate element generating sub-step of generating an intermediate element of a test question based on the initial element of the test question and the at least one preset database according to the preset condition; a test question judging sub-step of judging whether a test question consisting of the initial element and the intermediate element of the test question meets the preset condition, returning to the initial element generating sub-step or the intermediate element generating sub-step when the test question does not meet the preset condition, and proceeding to the test question generating sub-step when the test question meets the preset condition, and generating the test question based on the initial element and the intermediate element of the test question, wherein, one of the initial element of the test question and the intermediate element of the test question generated by the last execution of the intermediate element generating step of the test question serves as the answer of the test question, and the other of the two serves as the question of the test question.

In addition, according to another aspect of the present disclosure, the test question generating method, wherein the other test question intermediate elements except the test question intermediate elements generated by the last execution of the test question intermediate element generation sub-step correspond to the test question answer step.

In addition, the method for generating test questions according to another aspect of the present disclosure, wherein when the test questions meet the preset condition, generating the test questions based on the initial elements of the test questions and the intermediate elements of the test questions further comprises generating additional elements according to the constraint conditions of the test questions in the preset condition; and combining the initial element of the test question, the intermediate element of the test question and the additional element to generate the test question satisfying the constraint conditions of the test question.

In addition, according to another aspect of the present disclosure, the test question generating method, wherein the test question initial element generation sub-step comprises determining test sites based on the knowledge base database, the user history database and/or the user group pattern database.

In addition, according to another aspect of the present disclosure, the test question generating method, wherein the test question intermediate element generation sub-step comprises: determining a problem-solving idea based on the test question initial element and the at least one preset database.

In addition, according to the test paper generating method of another aspect of the present disclosure, when the test paper does not meet the preset condition, returning to the test paper generating step or the test paper generating step includes returning to the test paper generating step when multiple test questions do not meet the preset condition to regenerate one or more of the multiple test questions.

In addition, the test paper generating method according to another aspect of the present disclosure, wherein the test paper judging step comprises: generating a whole test paper constraint parameter based on the preset condition, wherein the whole test paper constraint parameter comprises one or more of a whole test paper question type parameter, a single question parameter of each test question, an associated parameter of each test question in the whole test paper, a generation time parameter and a maximum permissible error parameter; judging whether the multiple test questions meet the constraint parameters of the whole test paper.

In addition, the method for generating test questions according to another aspect of the present disclosure, wherein when the multiple test questions do not meet the preset condition, returning to the test paper generating step to regenerate one or more of the multiple test questions comprises dynamically adjusting the whole test paper constraint parameters and returning to the test paper generating step to regenerate one or more of the multiple test questions.

Furthermore, the test question generating method according to another aspect of the present disclosure, wherein the generation error of one or more of the multiple test questions is less than a predetermined threshold.

In addition, according to another aspect of the present disclosure, the test question generating method, wherein the test question initial element and the test question intermediate element respectively have corresponding first parameter range intervals, and the test question initial element and the test question intermediate element generated after returning to the test question initial element generating sub-step respectively have corresponding second parameter range intervals, and the second parameter range intervals are smaller than the first parameter range intervals.

According to another aspect of the present disclosure, there is provided a test question generating apparatus, including a preset condition receiving unit configured to receive a preset condition; a test question generating unit configured to generate test questions based on at least one preset database according to the preset condition; a test paper generating unit configured to organize a plurality of test questions to generate a test paper after the test question generating unit generates the plurality of test questions; a test paper judging unit configured to judge whether the test paper meets the preset condition, and when the test paper does not meet the preset condition, the test paper is regenerated by the test paper generating unit or regenerated by the test paper generating unit, and when the test paper meets the preset condition, the test paper is output.

According to another aspect of the present disclosure, there is provided a method for using a test question generating system, which comprises a preset condition receiving step of receiving a preset condition; a test question and test paper generating step of generating test questions and/or test papers according to the test question generating method; an answer result receiving step of receiving the answer result of the test questions and/or test papers answered by users; a step of recording the answer result, which records the answer result by taking the answer step as a unit; and a database updating step of updating the at least one preset database based on the answer result.

According to another aspect of the present disclosure, there is provided a test question generating system, including a preset condition receiving unit configured to receive preset condition; a test question and test paper generating unit configured to generate test questions and/or test papers using the test question generating method described above; the answer result receiving unit is configured to receive the answer result of the user answering the test questions and/or test papers; an answer result recording unit configured to record the answer result in units of answer steps; and a database updating unit configured to update the at least one preset database based on the answer result.

According to yet another aspect of the present disclosure, there is provided an electronic device including a memory for storing computer-readable instructions; and the processor is used for running the computer-readable instructions and executing the test question generating method.

According to another aspect of the present disclosure, there is provided a computer-readable storage medium for storing computer-readable instructions, which, when executed by a computer, cause the computer to perform the test question generating method as described above.

According to another aspect of the present disclosure, there is provided a computer program product, including computer program instructions, which, when executed by a processor, realize the test question generating method as described above.

As will be described in detail below, according to the test question generating method, test question generating apparatus, test question generating system, using method of test question generating system, electronic equipment, computer-readable storage medium and computer program product of the embodiment of the present disclosure, under the condition of no question bank, it is realized to provide users with a single test question or a complete set of test papers meeting different test forms in a targeted manner, and the difficulty, type and quantity of test questions can be flexibly configured according to the needs of users; In addition, the reform of teaching and assessment at any time requires providing the latest time-sensitive test questions, and updating relevant information and data according to the user's answer, so as to provide more accurate follow-up service.

It is to be understood that both the foregoing general description and the following detailed description are exemplary and are intended to provide further explanation of the claimed technology.

### BRIEF DESCRIPTION OF DRAWINGS

The above and other objects, features and advantages of the present disclosure will become more apparent by describing the embodiments of the present disclosure in more detail with reference to the accompanying drawings. The accompanying drawings are provided to provide a further understanding of the embodiments of the disclosure and constitute a part of the specification, and together with the embodiments of the disclosure, serve to explain the disclosure, and do not constitute a limitation of the disclosure. In the drawings, the same reference numerals generally represent the same parts or steps.

FIG. 1 is a schematic diagram outlining a test question generating system according to an embodiment of the present disclosure;

FIG. 2 is a flowchart illustrating a test question generating method according to an embodiment of the present disclosure;

FIG. 3 is a schematic diagram illustrating a test question generating method according to an embodiment of the present disclosure;

FIG. 4 is a schematic diagram specifically illustrating a test question generating method according to an embodiment of the present disclosure;

FIG. 5 is a flowchart illustrating a test question generating method according to an embodiment of the present disclosure;

FIG. 6 is a block diagram illustrating an examination question generating apparatus according to an embodiment of the present disclosure;

FIG. 7 is a block diagram illustrating another test question generating apparatus according to an embodiment of the present disclosure;

FIG. 8 is a flowchart illustrating a using method of the test question generating system according to an embodiment of the present disclosure;

FIG. 9 is a block diagram illustrating a test question generating system according to an embodiment of the present disclosure;

FIG. 10 is a hardware block diagram illustrating an electronic device according to an embodiment of the present disclosure; and

FIG. 11 is a schematic diagram illustrating a computer-readable storage medium according to an embodiment of the present disclosure.

### DETAILED DESCRIPTION OF THE INVENTION

In order to make the objects, technical solutions and advantages of the present disclosure more obvious, exemplary embodiments according to the present disclosure will be described in detail below with reference to the accompanying drawings. Obviously, the described embodiment is only a part of the embodiment of this disclosure, not all the embodiments of this disclosure, and it should be understood that this disclosure is not limited by the example embodiments described here.

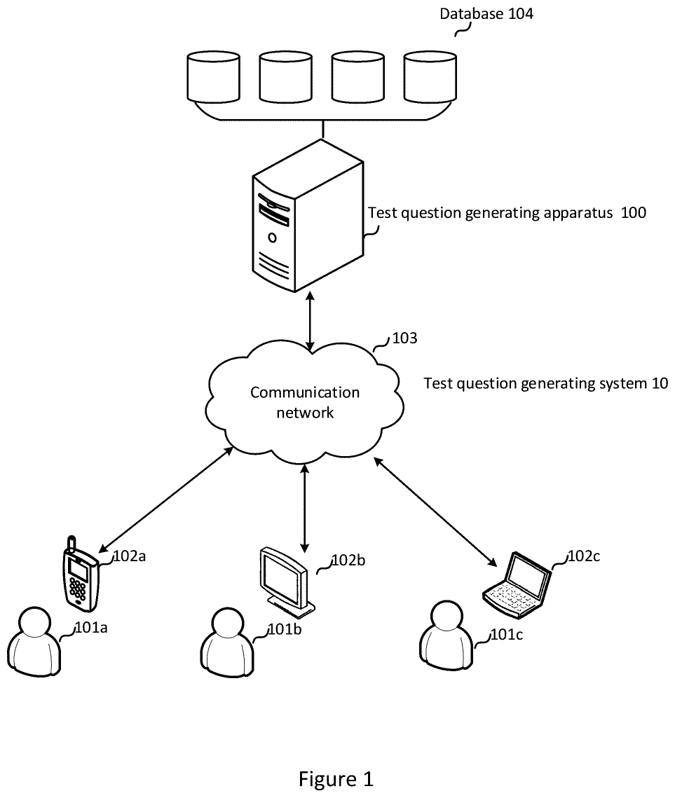

First, a test question generating system according to an embodiment of the present disclosure is schematically described with reference to FIG. 1.

As shown in FIG. 1, a test question generating system 10 is configured with a test question generating apparatus 100. Users 101a-101c access the test question generating apparatus 100 in the test question generating system 10 via the communication network 103 through their respective user devices 102a-102c, thereby using the test question generating service provided by the test question generating system 10.

Specifically, as shown in FIG. 1, in one embodiment of the present disclosure, the user devices 102a-102c and the test question generating apparatus 100 are operable to connect to the communication network 103 according to various wired or wireless communication protocols, such as transmission control protocol and Internet protocol (TCP/IP), user datagram protocol (UDP), hypertext transfer protocol (HTTP) and/or file transfer protocol (FTP). Examples of the communication network 103 may include, but are not limited to, the Internet, IPTV network, plain old telephone service (POTS), wireless fidelity (Wi-Fi) network, wireless local area network (WLAN), local area network (LAN) and/or metropolitan area network (MAN).

It should be understood that the test question generating apparatus 100 in the test question generating system 10 shown in FIG. 1 is merely exemplary, and in other embodiments of the present disclosure, the test question generating apparatus 100 according to the embodiment of the present disclosure may be, for example, suitable logic, circuits, interfaces and/or codes configured in user devices 102a-102c, which are used for providing test questions service to users 101a-101c.

The test question generating apparatus 100 in the test question generating system 10 according to the embodiment of the present disclosure is schematically configured with a database 104. Alternatively, the database 104 may be configured separately from the test question generating apparatus 100, and the test question generating apparatus 100 may access the database 104 according to various wired or wireless communication protocols.

As will be described in detail below, the test question generating system 10 according to the embodiment of the present disclosure does not directly screen out the possible test questions or test papers for users from a database such as a question bank by the test question generating apparatus 100, but in the absence of a question bank, it realizes providing users with a single test question or a complete set of test papers that meet different test forms in a targeted manner, and can flexibly configure the difficulty, type and quantity of test questions according to the needs of users. In addition, it is fulfilled to provide the latest time-sensitive test questions along with the reform requirements of teaching and assessment, and update relevant information and data according to the user's answer, so as to provide more accurate follow-up service.

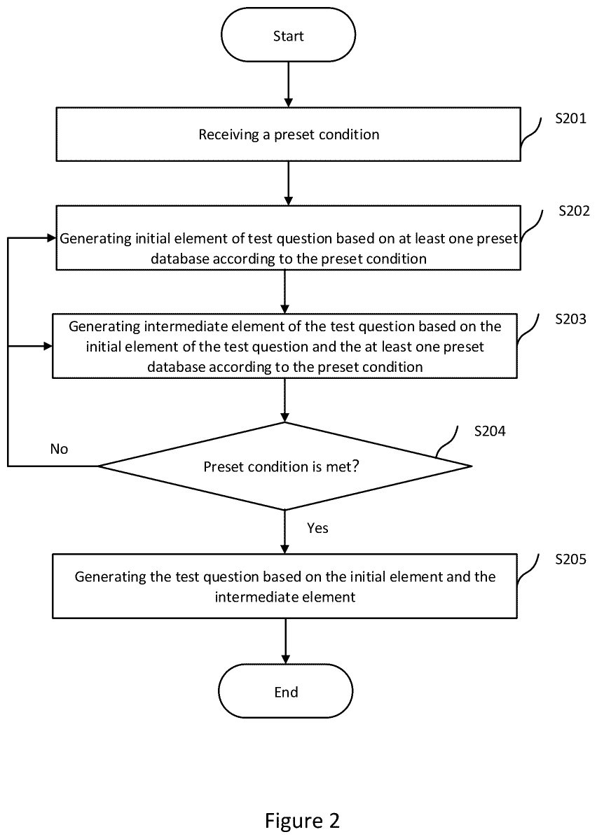

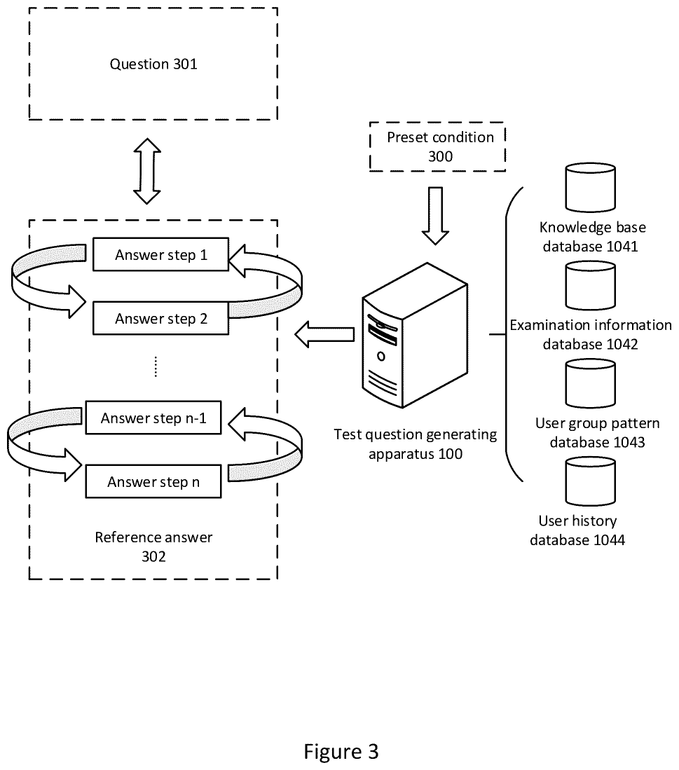

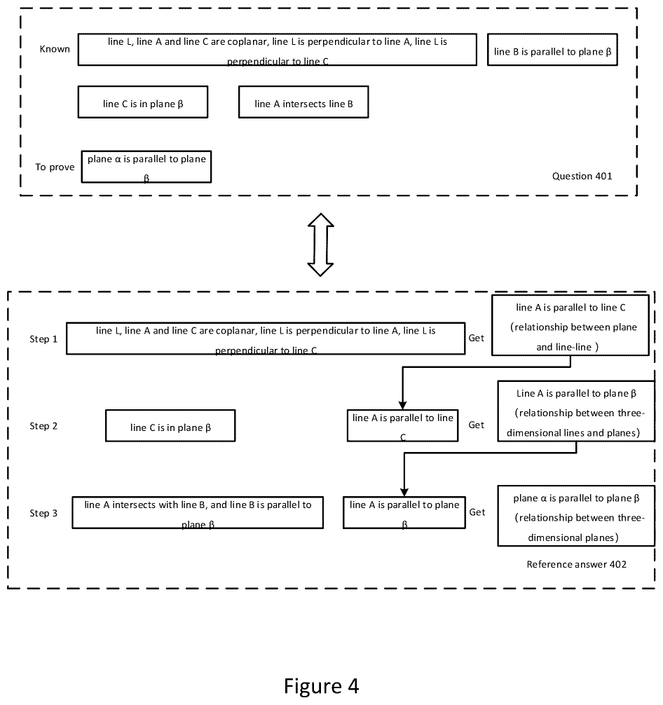

Next, with reference to FIGS. 2 to 4, the process of generating test questions according to the test question generating method of the embodiment of the present disclosure will be described. In which, FIG. 2 is a flowchart illustrating a test question generating method according to an embodiment of the present disclosure; FIG. 3 is a schematic diagram illustrating a test question generating method according to an embodiment of the present disclosure; FIG. 4 is a schematic diagram specifically illustrating a test question generating method according to an embodiment of the present disclosure.

As shown in FIGS. 2 and 3, the test question generating method according to the embodiment of the present disclosure includes the following steps.

In step S201, a preset condition receiving step is performed to receive a preset condition.

In one embodiment of the present disclosure, the test question generating apparatus 100 receives a preset condition 300 input by a user. The preset condition 300 include one or more of question type constraint condition, examination content constraint condition and examination style constraint condition. For example, the question type constraint condition in the preset condition 300 is used to set one or more of the whole paper, question-and-answer question, multiple-choice question, true-false question, fill-in-the-blank question, matching question and the like to be generated. The examination content constraint condition in the preset condition 300 is used to set one or more items of knowledge scope, difficulty, estimated completion time, etc. to be examined. The examination style constraint condition in the preset condition 300 is used to set one or more items such as the structure of the test paper and the style of test questions.

Alternatively, the preset condition 300 may be a preset condition that is automatically generated by the test question generating apparatus 100 according to the identified user and related information (such as the user's age, gender, grade, region, history record, etc.), which matches the current learning needs and learning progress of the user.

In step S202, an initial element generating step is performed, and initial element of test question is generated based on at least one preset database according to the preset condition.

In one embodiment of the present disclosure, the at least one preset database includes, for example, a knowledge base database 1041, an examination information database 1042, a user group pattern database 1043, and a user history database 1044.

Specifically, the knowledge base database 1041 is used to store information related to the knowledge to be examined, including one or more of basic knowledge information, common sense information, problem-solving idea information, problem-solving method information and error-prone point information.

The examination information base 1042 is used to store information related to examinations, including one or more of examination paper structure information, question type information, difficulty distribution information, examination time information and examination style information.

The user group pattern database 1043 is used to store information related to the user group, which is obtained based on the usage records of the user group, and includes one or more of problem-solving speed information, error-prone knowledge point information, problem-solving habit information and psychological acceptance limit information of a specific user group.

The user history database 1044 is used to store information related to a specific user, including one or more of the answering history information, knowledge mastery information and learning progress information of the specific user.

It is easily understood that the at least one preset database according to the embodiment of the present disclosure is not limited to the above-mentioned example database, but may include any other database. Similarly, the information stored in the at least one preset database is also not limited to the above example information, but may include any other information.

Further, the at least one preset database can be dynamically updated.

On the one hand, the knowledge base database 1041 can be dynamically updated according to the progress of teaching syllabus, teaching materials and teaching research, so as to ensure that it can adapt to the latest knowledge mastery requirements in real time; The examination information base 1042 can be dynamically updated according to the latest published examination syllabus and examination information, so as to ensure that it can adapt to the latest examination requirements in real time. In other words, through the dynamic update of the database, the timeliness and standardization of the question-setting are realized.

On the other hand, the user group pattern database 1043 and the user history database 1044 dynamically record the relevant information of specific users and specific user groups in real time, thus ensuring that targeted training can be provided for specific users and specific user groups.

In one embodiment of the present disclosure, taking the question-and-answer question as an example, according to the preset condition, based on at least one preset database, the generated initial element of question is the question 301 of the question-and-answer question. In another embodiment of the present disclosure, taking the question-and-answer question as an example, the initial element of the question is the last answer step n of the reference answer 302 of the question. That is to say, the test question generating method according to the embodiment of the present disclosure can generate an answer in a forward direction from the generation of a question, or can generate a question in a reverse direction from the generation of a final answer.

Specifically, the test question generating method according to the embodiment of the present disclosure determines the contents, types and styles to be examined according to the preset condition 300, and determines the test points to be examined based on the relevant information in the knowledge base database 1041, the user group mode database 1043 and the user history database 1044, and ensures that the generated results conform to the specifications of the actual test based on the examination information database 1042. In addition, the default user group parameters in the user group pattern database 1043 can be used for first-time users or users with insufficient relevant records in the user history database 1044.

In step S203, the intermediate element generating step is performed, and the intermediate element of the test question is generated based on the initial element of the test question and the at least one preset database according to the preset condition.

In one embodiment of the present disclosure, taking the question-and-answer question as an example, after the question 301 of the test question is generated in step 202, the intermediate element of the test question is generated in step S203 as the answer step 1. In another embodiment of the present disclosure, taking the question-and-answer question as an example, after the last answer step n of the reference answer 302 of the test question is generated in step 202, the intermediate element of the test question is generated as the answer step n−1 in step S203.

Specifically, the test question generating method according to the embodiment of the present disclosure uses the relevant data of the at least one preset database to evaluate which problem-solving idea should be used to construct the test question based on the initial element of the test question (for example, the generating result of the answer step n), so that the association between the answer step n−1 and the answer step n is optimized and meets the preset condition.

In step S204, a test question judging step is performed to judge whether the test question composed of t the initial element of the test question and the intermediate element of the test question meets the preset condition.

If a negative result is obtained in step S204, that is, the test question composed of the initial element of the test question and the intermediate element of the test question does not meet the preset condition, the method returns to the initial element generating step S202 or the intermediate element generating step S203.

Specifically, by returning to the question initial element generating step S202 or the question intermediate element generating step S203, more intermediate problem-solving steps can be generated (for example, the answer step n−2 is generated after the answer step n−1 until the answer step 1), or the answer step n−1 or the answer step n that has been generated previously can be regenerated by adjusting the generating parameters, so that the test question composed of the question initial element and the question intermediate element meeting the preset condition can be finally generated.

If a positive result is obtained in step S204, that is, the test question composed of the initial element of the test question and the intermediate element of the test question meets the preset condition, the processing proceeds to step S205.

In step S205, a test question generating step is performed to generate the test question based on the initial element and the intermediate element of the test question.

Specifically, one of the initial element of the test question and the intermediate element of the test question generated by the last execution of the intermediate element generating step of the test question is used to generate the answer of the test question, and the other of the two is used to generate the question of the test question. Other intermediate elements of the test question except the intermediate elements of the test question generated in the intermediate element generating step of the test question for the last time correspond to the answer steps of the test question.

That is, in one embodiment of the present disclosure, after the question 301 of the test question is generated in step 202 by taking the question-and-answer question as an example, the intermediate element of the test question generated in step S203 is the last answer step n of the reference answer 302. In another embodiment of the present disclosure, taking the question-and-answer question as an example, after the last answer step n of the reference answer 302 of the question is generated in step 202, the intermediate element of the test question generated in the intermediate element generating step S203 performed for the last time is the question 301 of the test question.

In addition, when the test question meets the preset condition, generating the test question based on the initial element of the test question and the intermediate element of the test question further includes generating additional element according to the constraint conditions of the test question in the preset condition, and combining the initial element of the test question, the intermediate element of the test question and the additional element to generate the test question satisfying the constraint conditions of the test question.

In one embodiment of the present disclosure, the additional element may be the related descriptive text. For example, the direct generated content is: using collocation method: x²+4x−5=(x+5) (x−1). After generating related additional element, the final combined content is: because it does not conform to the complete square formula, but −5=−1x5, 4=5−1, it conforms to the use conditions of the collocation method, so the collocation method is used here: x²+4x−5=(x+5) (x−1).

In addition, generating additional element according to the question constraint condition in the preset condition also includes generating additional element according to different question types and combining them. For example. In the case of multiple-choice question, the stem of multiple-choice question and the corresponding correct options are generated by using the existing initial element and intermediate element of the question, and other wrong options are optionally supplemented. When the question type is true or false, the stem of the true or false question and the corresponding correct expression are generated by using the existing initial element and intermediate element of the question, and other wrong expressions can be optionally supplemented. When the question type is a fill-in-the-blank question, the stem of the fill-in-the-blank question and the corresponding vacancy part are generated by using the existing initial element and intermediate element of the question. When the question type is a matching question, the corresponding relationship of the matching question is generated by using the existing initial element and intermediate element of the question, and the related graphics are optionally supplemented.

As mentioned above, the test question generating method according to the embodiment of the present disclosure controls and adjusts the test question generating process by taking the answer step as the smallest unit, and can adjust the generating parameters of one or more answer steps to meet the final goal, and each answer step can accurately correspond to the corresponding knowledge point and problem-solving idea, thus realizing more accurate and targeted question-setting service.

For example, in one embodiment of the present disclosure, after the initial element generating step S202 or the intermediate element generating step S203 is performed for the first time, the test question with the initial element and the intermediate element or their combination have a first parameter range interval, while the test question with the initial element and the intermediate element or their combination generated after returning to the initial element generating step S202 or the intermediate element generating step S203 have a second parameter range interval. The second parameter range interval is smaller than the first parameter range interval. That is, the parameter range is gradually narrowed by iteration.

For example, take the range of difficulty parameter as an example. The range of difficulty parameter generated for the first time is:
a. Step 1:73^{˜}75;
b. Step 2: 7^{˜}10.5;
c. Step 3: 5^{˜}20.

Re-executing the initial element generating step S202 or the intermediate element generating step S203 of the test question, that is, gradually narrowing the parameter interval to obtain a new difficulty parameter range:
a. Step 1: 73^{˜}74.2;
b. Step 2: 8.2^{˜}9.1;
c. Steps 3: 6^{˜}11.3.

After several rounds of iteration, the final difficulty parameter is obtained:
a. Step 1: 73.5;
b. Step 2:8.7;
c. Step 3: 8.2.

It should be noted that the relevant parameters in the process of generating test question can be visually transformed. For example, for a certain test question, you can show the user its related parameters as follows:
Target test benchmark difficulty: 60
Knowledge examination difficulty: 82
Calculation difficulty: 71
Thinking difficulty: 93.

In addition, for example, for a certain test question, you can also add relevant comments for users: the difficulty is similar to the second question of the college entrance examination finale, focusing on the problem-solving ideas.

FIG. 4 specifically illustrates a test question generating method according to an embodiment of the present disclosure.

As shown in FIG. 4, firstly, a preset condition receiving step is performed to receive a preset condition. In the example of FIG. 4, the preset condition is, for example, to generate a proof question, which is used to test the knowledge point of geometric plane relation, line plane relation and line-line relation of geometric solid. The examination difficulty is moderate, and the predicted answer time is 2 minutes.

Thereafter, according to the preset condition, based on at least one preset database, initial elements of test question is generated. In the example of FIG. 4, the initial element of the test question is the last answer step 3 of the reference answer 402 of the test question, that is, “line A intersects with line B, and line B is parallel to plane β” combined with “line A is parallel to plane β” to obtain “plane α is parallel to plane β”, which examines the relationship between three-dimensional planes.

Thereafter, an intermediate element generating step is performed, and an intermediate element of the test question is generated based on the initial element of the test question and the at least one preset database according to the preset condition. In the example of FIG. 4, the intermediate elements of the test question generated in step S203 are answer steps 2 and 1. That is, the answer step 2 is generated first, that is, “Line C is in plane β” “Line A is parallel to Line C” to get “Line A is parallel to plane β”, which examines the relationship between three-dimensional lines and planes. At this time, the test question judging step judges that the test question composed of the initial element of the test question and the intermediate element of the test question does not meet the preset condition, for example, the knowledge point that needs to be examined defined by the preset condition of “plane line-line relationship” is not examined. In this case, return to the intermediate element generating step and generate the answer step 1 again, that is, “Line L, Line A and Line C are coplanar, Line L is perpendicular to Line A, and Line L is perpendicular to Line C” gets “Line A is parallel to Line C”, which examines the plane line-line relationship. At this time, the test question judging step judges that the test question composed of the initial element of the test question and the intermediate element of the test question meets the preset condition.

Thereafter, a test question generating step is performed to generate the test question based on the initial element of the test question and the intermediate element of the test question. In the example of FIG. 4, the generated question 401 is that “line L, line A and line C are coplanar, line L is perpendicular to line A, line L is perpendicular to line C”, “line B is parallel to plane β”, “line C is in plane β” and “line A intersects line B”, and it is proved that “plane α is parallel to plane β”.

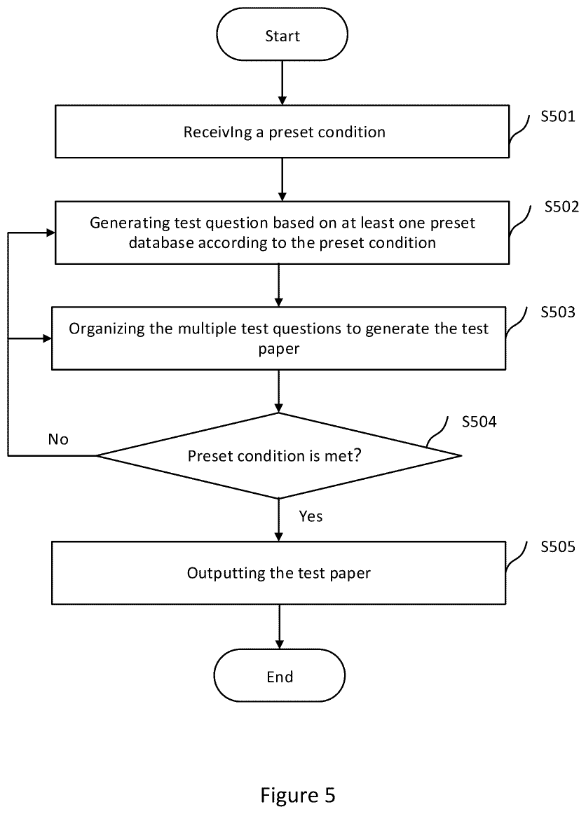

Above, the process of generating test questions according to the test question generating method of the embodiment of the present disclosure has been described with reference to FIGS. 2 to 4. Hereinafter, the process of generating test paper according to the test question generating method of the embodiment of the present disclosure will be described with further reference to FIG. 5.

In step S501, a preset condition receiving step is performed to receive a preset condition.

Similar to step S201 shown in FIG. 2, in one embodiment of the present disclosure, a preset condition input by a user is received. The preset condition includes one or more of question type constraint condition, examination content constraint condition and examination style constraint condition. For example, the question type constraint condition in the preset condition is used to set one or more of the whole paper, question-and-answer question, multiple-choice question, true-false question, fill-in-the-blank question, matching question, etc. to be generated. The examination content constraint condition in the preset condition is used to set one or more items of knowledge scope, difficulty, estimated completion time, etc. to be examined. The examination style constraint condition in the preset condition is used to set one or more items such as the structure of test paper and the style of test questions.

Alternatively, the preset condition can also be automatically generated according to the identified user and its related information (such as the user's age, gender, grade, region, history record, etc.) to match the current learning needs and learning progress of the user.

In step S502, a test question generating step is performed, and test questions are generated based on at least one preset database according to the preset condition. In an embodiment of the present disclosure, step S502 corresponds to steps S201 to S205 described above with reference to FIG. 2, that is, a single test question is generated by the test question generating method according to the embodiment of the present disclosure. That is to say, the test question generating step includes an initial element generating sub-step of generating an initial element of the test question based on at least one preset database according to the preset condition; An intermediate element generating sub-step of generating an intermediate element of a test question based on the initial element of the test question and the at least one preset database according to the preset condition; a test question judging sub-step of judging whether a test question composed of the initial element and the intermediate element of the test question meets the preset condition, returning to the initial element generating sub-step or the intermediate element generating sub-step when the test question does not meet the preset condition, and proceeding to the test question generating sub-step when the test question meets the preset condition, and generating the test question based on the initial element and the intermediate element of the test question, wherein one of the initial element of the test question and the intermediate element of the test question generated by the last execution of the intermediate element generating step of the test question serves as the answer of the test question, and the other of the two serves as the question of the test question. The other intermediate elements of the test question correspond to the answer steps of the test question except the intermediate element of the test question generated by the last execution of the intermediate element generating sub-step of the test question. When the test questions meet the preset condition, generating the test question based on the initial element of the test question and the intermediate element of the test question further includes generating additional element according to the constraint condition of the test question in the preset condition; and combining the initial element of the test question, the intermediate element of the test question and the additional element to generate the test question satisfying the constraint condition of the test question. Wherein the sub-step of generating the initial element of the test questions comprises: determining the test points based on the knowledge base database, the user history database and/or the user group pattern database. And wherein the sub-step of generating the intermediate element of the test question comprises: determining a problem-solving idea based on the initial element of the test question and the at least one preset database.

In step S503, a test paper generating step is performed, and after the test paper generating step is repeatedly performed for many times to generate multiple test questions, the multiple test questions are organized to generate the test paper.

In step S504, a test paper judging step is performed to judge whether the test paper meets the preset condition. In one embodiment of the present disclosure, judging whether the test paper meets the preset condition includes: generating a whole test paper constraint parameter based on the preset condition, wherein the whole test paper constraint parameter includes one or more of a whole test paper question type parameter, a single question parameter of each test question, an associated parameter of each test question in the whole test paper, a generation time parameter and a maximum permissible error parameter; judging whether the multiple test questions meet the constraint parameter of the whole test paper.

When a negative result is obtained in step S504, that is, the test paper does not meet the preset condition, it returns to the test paper generating step S502 or the test paper generating step S503.

In one embodiment of the present disclosure, the test question generating step S502 is returned to regenerate one or more of the multiple test questions. More specifically, for a specific test question, specific steps can be regenerated.

In one embodiment of the present disclosure, returning to the test question generating step S503 includes dynamically adjusting the whole test paper constraint parameters and returning to the test paper generating step to regenerate one or more of the multiple test questions so that the generation error of one or more of the multiple test questions is less than a predetermined threshold.

When a positive result is obtained in step S504, that is, the test paper meets the preset condition, the processing proceeds to step S505, and the test paper is output.

In the case of no question bank, the test question generating method according to the embodiment of the present disclosure described with reference to FIG. 5 provides users with a complete set of test paper meeting different test forms with the minimum unit of knowledge points involved in the problem-solving step, and can flexibly configure the difficulty, type and quantity of test questions according to the needs of users.

Above, the test question generating method according to the embodiment of the present invention was described with reference to the drawings. Hereinafter, a test question generating apparatus according to an embodiment of the present disclosure will be described.

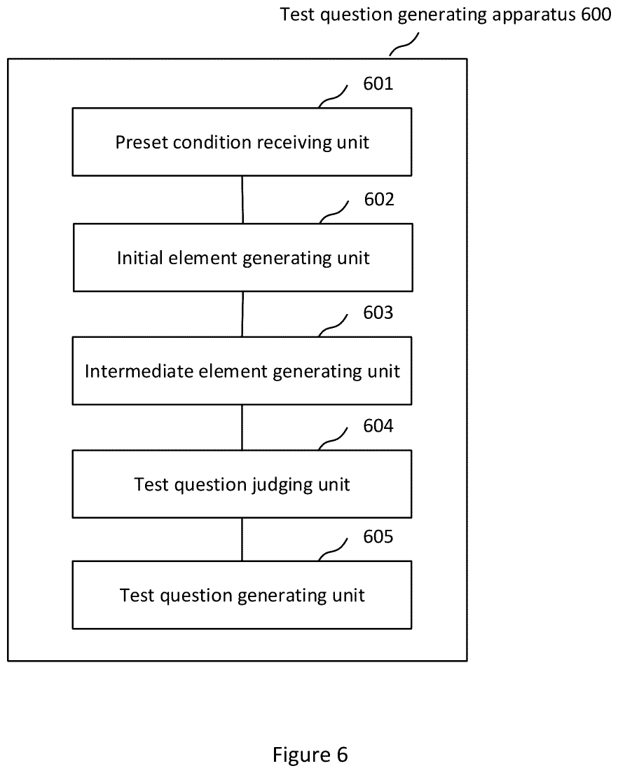

FIG. 6 is a block diagram illustrating an test question generating apparatus according to an embodiment of the present disclosure. As shown in FIG. 6, the test question generating apparatus 600 according to the embodiment of the present disclosure includes a preset condition receiving unit 601, an initial element generating unit 602, an intermediate element generating unit 603, a test question judging unit 604 and a test question generating unit 605. Each of the above modules can respectively perform the process of generating test question according to the test question generating method of the embodiment of the present disclosure as described above with reference to FIGS. 2 to 4. It is understood by those skilled in the art that these unit modules can be realized in various ways by hardware alone, software alone, or a combination thereof, and the present disclosure is not limited to any of them.

The preset condition receiving unit 601 is configured to receive a preset condition. In one embodiment of the present disclosure, the preset condition receiving unit 601 receives a preset condition input by a user. The preset condition includes one or more of question type constraint condition, examination content constraint condition and examination style constraint condition. For example, the question type constraint condition in the preset condition is used to set one or more of the whole paper, question-and-answer question, multiple-choice question, true-false question, fill-in-the-blank question, matching question, etc. to be generated. The examination content constraint in the preset condition is used to set one or more items of knowledge scope, difficulty, estimated completion time, etc. to be examined. The examination style constraint condition in the preset condition is used to set one or more items such as used to set one or more items such as the structure of the test paper and the style of test questions. In another embodiment of the present disclosure, the preset condition receiving unit 601 automatically generates preset condition that match the user's current learning needs and learning progress according to the identified user and its related information (such as the user's age, gender, grade, region, history record and so on).

The initial element generating unit 602 is configured to generate initial element of test question based on at least one preset database according to the preset condition. In one embodiment of the present disclosure, the at least one preset database includes, for example, a knowledge base database, an examination information database, a user group pattern database, and a user history database. Specifically, the knowledge base database is used to store information related to the knowledge to be examined, including one or more of basic knowledge information, common sense information, problem-solving idea information, problem-solving method information and error-prone point information. The examination information base is used to store information related to examinations, including one or more of examination paper structure information, question type information, difficulty distribution information, examination time information and examination style information. The user group pattern database is used to store information related to the user group, and the information related to the user group is obtained based on the usage records of the user group, including one or more of problem-solving speed information, error-prone knowledge point information, problem-solving habit information and psychological acceptance limit information of a specific user group. The user history database is used to store information related to a specific user, including one or more of answer history information, knowledge mastery information and learning progress information of that specific user. It is easily understood that the at least one preset database according to the embodiment of the present disclosure is not limited to the above-mentioned example database, but may include any other database. Similarly, the information stored in the at least one preset database is also not limited to the above example information, but may include any other information.

On the one hand, the knowledge base database can be dynamically updated according to the progress of teaching syllabus, teaching materials and teaching research, so as to ensure that it can adapt to the latest knowledge mastery requirements in real time; The examination information base can be dynamically updated according to the latest published examination syllabus and examination information, so as to ensure that it can adapt to the latest examination requirements in real time. In other words, through the dynamic update of the database, the timeliness and standardization of the question-setting are realized.

On the other hand, the user group pattern database and the user history database dynamically record the relevant information of specific users and specific user groups in real time, thus ensuring that targeted training can be provided for specific users and specific user groups.

In one embodiment of the present disclosure, taking the question-and-answer question as an example, the initial element generating unit 602 generates an initial element test question that is a question of the test question based on at least one preset database according to the preset condition. In another embodiment of the present disclosure, taking the question-and-answer question as an example, the initial element of the test question generated by the initial element generating unit 602 is the last answer step n of the reference answer of the test question. That is to say, the initial element generating unit 602 according to the embodiment of the present disclosure can generate an answer in a forward direction from generating a question, or can generate a question in a reverse direction from generating a final answer.

Specifically, the initial element generating unit 602 determines the content, question type and style to be examined according to preset condition, and determines the test points to be examined based on relevant information in the knowledge base database, the user group pattern database and the user history database, and ensures that the generated results conform to the specifications of the actual examination based on the examination information base. In addition, for first-time users or users with insufficient relevant records in the user history database, the default group user parameters in the user group pattern database can be used.

The intermediate element generating unit 603 is configured to generate intermediate elements of the test questions based on the initial element of the test question and the at least one preset database according to the preset condition. In one embodiment of the present disclosure, taking the question-and-answer question as an example, after the initial element generating unit 602 generates the question 301 of the test question, the intermediate element generating unit 603 generates the intermediate element of the test question as the answer step 1. In another embodiment of the present disclosure, taking the question-and-answer question as an example, after the last answer step n of the reference answer 302 of the question is generated by the initial element generating unit 602, the intermediate element generating unit 603 generates the intermediate element of the question as the answer step n−1.

Specifically, the intermediate element generating unit 603 uses the relevant data of the at least one preset database to evaluate which problem-solving idea should be used to construct the test question based on the initial element of the test question (for example, the generating result of the answer step n), so that the association between the answer step n−1 and the answer step n is optimized and meets the preset condition.

The test question judging unit 604 is configured to judge whether the test question composed of the test question initial element and the test question intermediate element meets the preset condition, and when the test question does not meet the preset condition, it is returned to the test question initial element generating unit 602 or the test question intermediate element generating unit 603 to regenerate the test question initial element.

When the test question meets the preset condition, the test question is generated by the test question generating unit 605 based on the initial element and the intermediate element of the test question, wherein one of the initial element and the intermediate element of the test question generated by the intermediate element generating unit for the last time is used for generating the answer of the test question, and the other is used for generating the question of the test question. Other intermediate elements of the test questions except the intermediate elements of the test questions generated in the step of generating intermediate elements of the test question for the last time correspond to the answer step of the test questions.

That is to say, in one embodiment of the present disclosure, after the initial element generating unit 602 generates the question of the test questions, the intermediate element of the test question generated by the intermediate element generating unit 603 for the last time is the last answer step n of the reference answer. In another embodiment of the present disclosure, taking the question-and-answer question as an example, after the initial element generating unit 602 generates the last answer step n of the reference answer of the test question, the intermediate element of the test question generated by the intermediate element generating unit 603 for the last time is the question of the test question.

In addition, when the test questions meet the preset condition, the test question generating unit 605 also generates additional element according to the question type constraint condition of the test question in the preset condition, and combines the initial element of the test question, the intermediate element of the test question and the additional element to generate the test question satisfying the constraint conditions of the test question.

In one embodiment of the present disclosure, the additional element may be the related descriptive text. For example, the direct generated content is: using collocation method: x²+4x−5=(x+5) (x−1). After generating related additional element, the final combined content is: because it does not conform to the complete square formula, but −5=−1x5, 4=5−1, it conforms to the use conditions of the collocation method, so the collocation method is used here: x²+4x−5=(x+5) (x−1).

In addition, generating additional element according to the question constraint condition in the preset condition also includes generating additional element according to different question types and combining them. For example. In the case of multiple-choice question, the stem of multiple-choice question and the corresponding correct options are generated by using the existing initial element and intermediate element of the question, and other wrong options are optionally supplemented. When the question type is true or false, the stem of the true or false question and the corresponding correct expression are generated by using the existing initial element and intermediate element of the question, and other wrong expressions can be optionally supplemented. When the question type is a fill-in-the-blank question, the stem of the fill-in-the-blank question and the corresponding vacancy part are generated by using the existing initial element and intermediate element of the question. When the question type is a matching question, the corresponding relationship of the matching question is generated by using the existing initial element and intermediate element of the question, and the related graphics are optionally supplemented.

As described above, the test question generating apparatus 600 according to the embodiment of the present disclosure controls and adjusts the test question generating process by taking the answer step as the smallest unit, and can adjust the generating parameters of one or more answer steps to meet the final goal, and each answer step can accurately correspond to the corresponding knowledge point and problem-solving idea, thus realizing more accurate and targeted question-setting service.

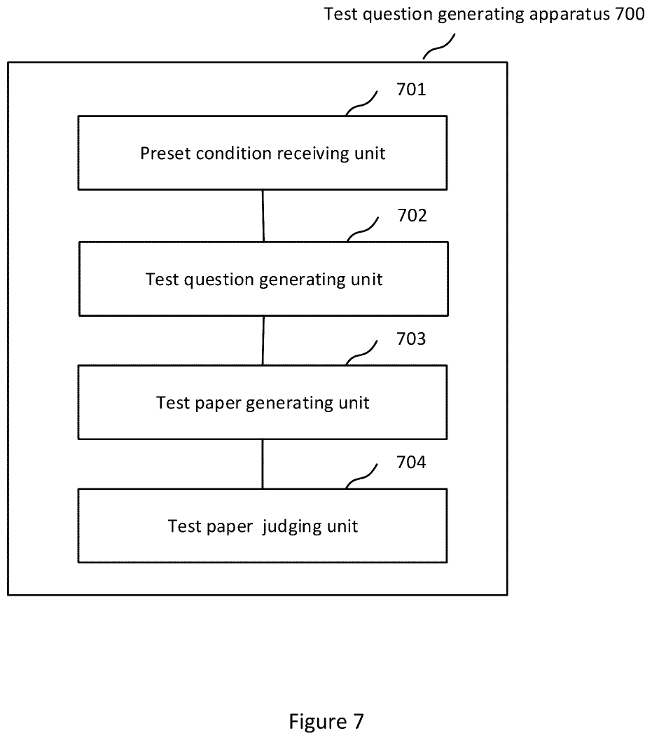

FIG. 7 is a block diagram illustrating another test question generating apparatus according to an embodiment of the present disclosure. As shown in FIG. 7, the test question generating apparatus 700 according to the embodiment of the present disclosure includes a preset condition receiving unit 701, a test question generating unit 702, a test paper generating unit 703 and a test paper judging unit 704. Each of the above modules can respectively perform the process of generating test paper according to the test question generating method according to the embodiment of the present disclosure as described above with reference to FIG. 5. It is understood by those skilled in the art that these unit modules can be realized in various ways by hardware alone, software alone, or a combination thereof, and the present disclosure is not limited to any of them.

The preset condition receiving unit 701 is configured to receive a preset condition. Similar to the preset condition receiving unit 601 shown in FIG. 6, in one embodiment of the present disclosure, the preset condition receiving unit 701 receives a preset condition input by a user. The preset condition includes one or more of question type constraints, examination content constraints and examination style constraints. For example, the question constraint conditions in the preset condition are used to set one or more of the whole paper, question-and-answer questions, multiple-choice questions, true-false questions, fill-in-the-blank questions, connection questions, etc. to be generated. The examination content constraint condition in the preset condition is used to set one or more items of knowledge scope, difficulty, estimated completion time, etc. to be examined. The examination style constraint condition in the preset condition is used to set one or more items such as test paper structure, question style, etc. Alternatively, the preset condition receiving unit 701 can automatically generate the preset condition that matches the current learning needs and learning progress of the user according to the identified user and its related information (such as the user's age, gender, grade, region, history record, etc.).

The test question generating unit 702 is configured to generate the test question based on at least one preset database according to the preset condition. In one embodiment of the present disclosure, the test question generating unit 702 performs processing corresponding to that performed by the test question generating apparatus 600 described above with reference to FIG. 6.

The test paper generating unit 703 is configured to organize a plurality of test questions to generate a test paper after the test question generating unit generates the plurality of test questions.

The test paper judging unit 704 is configured to judge whether the test paper meets the preset condition. In one embodiment of the present disclosure, the test paper judging unit 704 generates a whole test paper constraint parameter based on the preset condition, wherein the whole test paper constraint parameter includes one or more of a whole test paper question type parameter, a single question parameter of each question, an associated parameter of each question in the whole test paper, a generation time parameter and a maximum permissible error parameter, and judges whether the plurality of test questions meet the constraint parameters of the whole test paper.

When the test paper does not meet the preset condition, the test paper is regenerated by the test question generating unit 702 or by the test paper generating unit 703. When the test paper meets the preset condition, the test paper is output.

In one embodiment of the present disclosure, the test question generating unit 702 regenerates one or more of the multiple test questions. More specifically, the test question generating unit 702 can regenerate specific steps for a specific test question.

In one embodiment of the present disclosure, the test paper generating unit 703 dynamically adjusts the whole test paper constraint parameters to regenerate one or more of the multiple test questions, so that the generation error of one or more of the multiple test questions is less than a predetermined threshold.

As mentioned above, the test question generating apparatus 700 according to the embodiment of the present disclosure can provide users with a complete set of test paper that meet different test forms with the minimum unit of knowledge points involved in the problem-solving steps, and can flexibly configure the difficulty, type and quantity of test questions according to the needs of users.

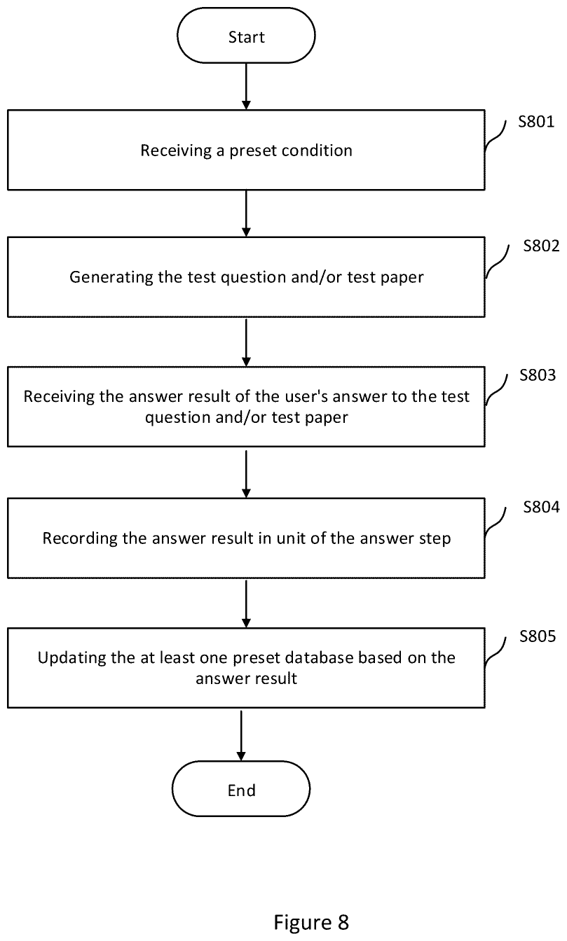

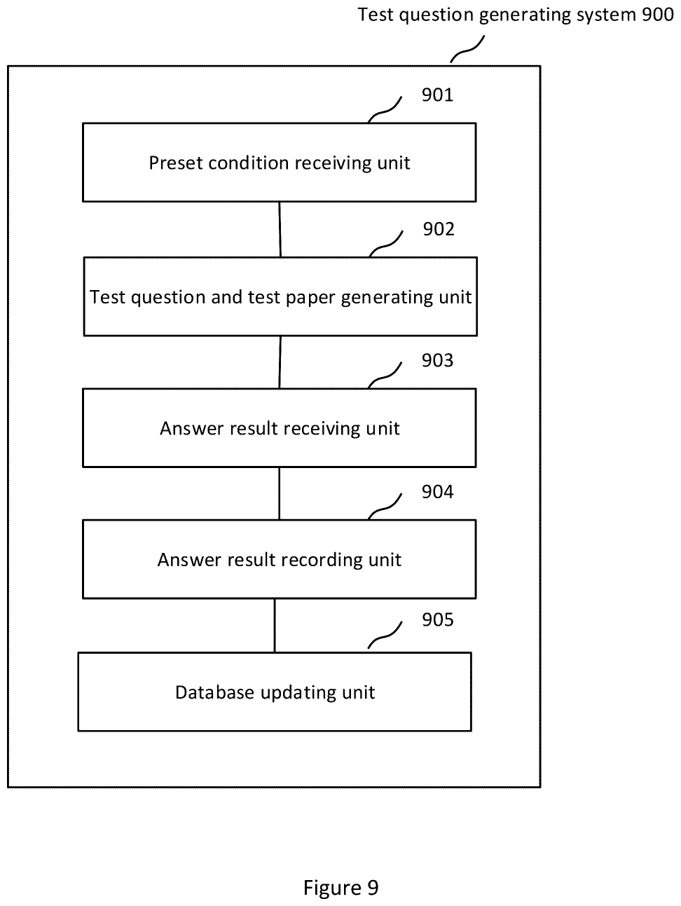

Above, the process of generating test questions or test papers by the test question generating method and apparatus according to the embodiment of the present disclosure has been described. As outlined above with reference to FIG. 1, the test question generating system using the test question generating method according to the embodiment of the present disclosure can realize the update of relevant information and data through interaction with users, and provide a more accurate test question service in the future. Hereinafter, a test question generating system and a using method thereof according to an embodiment of the present disclosure will be described with reference to FIGS. 8 and 9. FIG. 8 is a flowchart illustrating a using method of the test question generating system according to an embodiment of the present disclosure; FIG. 9 is a block diagram illustrating a test question generating system according to an embodiment of the present disclosure.

As shown in FIG. 8, the using method of the test question generating system according to the embodiment of the present disclosure includes the following steps.

In step S801, a preset condition receiving step is performed to receive a preset condition.

Similar to step S201 shown in FIG. 2 and step S501 shown in FIG. 5, in one embodiment of the present disclosure, in step S801, a preset condition input by a user is received. The preset condition includes one or more of question type constraint condition, examination content constraint condition and examination style constraint condition. For example, the question constraint conditions in the preset condition are used to set one or more of the whole paper, question-and-answer question, multiple-choice question, true-false question, fill-in-the-blank question, matching question and the like to be generated. The examination content constraint condition in the preset condition is used to set one or more items of knowledge scope, difficulty, expected completion time, etc. to be examined. The examination style constraint condition in the preset condition is used to set one or more items such as test paper structure, question style, etc.

Alternatively, in step S801, the preset condition can also be automatically generated according to the identified user and related information (such as the user's age, gender, grade, region, history record, etc.) to match the user's current learning needs and learning progress.

In step S802, a test question and test paper generating step is performed to generate the test question and/or test paper. It is easy to understand that in step S802, the test question generating method described with reference to FIGS. 2 to 4 can be performed to generate the test question, or the test question generating method described with reference to FIG. 5 can be performed to generate the test paper. It should be noted that the test question generating method performed by the test question generating system according to the embodiment of the present disclosure can control and adjust the test question generation process with the answer steps as the minimum unit, and the generation parameters of one or more answer steps can be adjusted to meet the final goal, and each answer step can accurately correspond to the corresponding knowledge point and problem-solving idea. Similarly, the test paper generating method performed by the test paper generating system according to the embodiment of the present disclosure can provide users with a complete set of test paper that meets different test forms in a targeted manner with the knowledge points involved in the problem-solving step as the minimum unit without a question bank, and can flexibly configure the difficulty, type and quantity of test paper according to the needs of users.

In step S803, the answer result receiving step is performed to receive the answer result of the user's answer to the test question and/or test paper. In one embodiment of the present disclosure, the answer result receiving unit receives an online answer from a user to a test question or a test paper. In another embodiment of the present disclosure, the test question and/or test paper are provided to users in an off-line way, for example, in the form of standard test paper. After that, the answered test papers fed back by users are collected and the corresponding answer results are identified.

In step S804, the answer result recording step is performed, and the answer result is recorded in unit of the answer step. Because the test question/test paper generating method performed by the test question generating system according to the embodiment of the present disclosure controls and adjusts the test question/test paper generation process with the answer step as the minimum unit, correspondingly, the answer result of the user is also recorded with the answer step as the minimum unit, so that the user's mastery of each answer step can be clearly defined.

In step S805, a database updating step is performed to update the at least one preset database based on the answer result. In one embodiment of the present disclosure, based on the answer result, the user group pattern database and the user history database are updated, so as to record the user's or user group's mastery of specific knowledge points corresponding to the answer step, so as to provide more accurate question-setting service later.

FIG. 9 is a block diagram illustrating a test question generating system according to an embodiment of the present disclosure. As shown in FIG. 9, the test question generating system 900 according to the embodiment of the present disclosure includes a preset condition receiving unit 901, a test question and test paper generating unit 902, an answer result receiving unit 903, an answer result recording unit 904 and a database updating unit 905. It is understood by those skilled in the art that these unit modules can be realized in various ways by hardware alone, software alone, or a combination thereof, and the present disclosure is not limited to any of them.

The preset condition receiving unit 901 is configured to receive preset condition. Similar to the preset condition receiving unit 601 shown in FIG. 6 and the preset condition receiving unit 701 shown in FIG. 7, in one embodiment of the present disclosure, the preset condition receiving unit 901 receives a preset condition input by a user. The preset condition includes one or more of question type constraints, examination content constraints and examination style constraints. For example, the question type constraint condition in the preset condition is used to set one or more of the whole paper, question-and-answer question, multiple-choice question, true-false question, fill-in-the-blank question, matching question and the like to be generated. The examination content constraint in the preset condition is used to set one or more items of knowledge scope, difficulty, estimated completion time, etc. to be examined. The examination style constraint condition in the preset condition is used to set one or more items such as test paper structure, question style, etc.

Alternatively, the preset condition receiving unit 901 automatically generates preset condition that matches the user's current learning needs and learning progress according to the identified user and its related information (such as the user's age, gender, grade, region, history record, etc.).

The test question and test paper generating unit 902 is configured to generate test question and/or test paper. It is easy to understand that the test question and test paper generating unit 902 may perform the test question generating method described with reference to FIGS. 2 to 4 to generate test question, or may perform the test question generating method described with reference to FIG. 5 to generate test paper. It should be noted that the test question generating method performed by the test question and test paper generating unit 902 can control and adjust the test question generation process with the answer steps as the minimum unit, and the generation parameters of one or more answer steps can be adjusted to meet the final goal, and each answer step can accurately correspond to the corresponding knowledge points and problem-solving ideas. Similarly, the test paper generating method performed by the test paper and test paper generating unit 902 can provide users with a complete set of test paper that meets different test forms in a targeted manner with the knowledge points involved in the problem-solving step as the minimum unit without a question bank, and can flexibly configure the difficulty, type and quantity of test papers according to the needs of users.

The answer result receiving unit 903 is configured to receive the answer result of the user answering the test question and/or test paper. In one embodiment of the present disclosure, the answer result receiving unit 903 receives an online answer from a user to a test question or a test paper. In another embodiment of the present disclosure, test question and/or test paper are provided to users in an off-line way, for example, in the form of standard test papers. Thereafter, the answered test paper fed back by the user is recovered, and the answer result receiving unit 903 identifies the corresponding answer result.

The answer result recording unit 904 is configured to record the answer result in units of answer step. Since the test question and test paper generating unit 902 controls and adjusts the question/test paper generation process with the answer step as the minimum unit, the corresponding answer result recording unit 904 also records the answer result of the user with the answer step as the minimum unit, so that the user's mastery of each answer step can be clarified.

The database updating unit 905 is configured to update the at least one preset database based on the answer result. In one embodiment of the present disclosure, the database updating unit 905 updates the user group pattern database and the user history database based on the answer result, so as to record the user's or user group's mastery of the specific knowledge points corresponding to the answer step, so that the test question generating system 900 can provide more accurate test question service later.

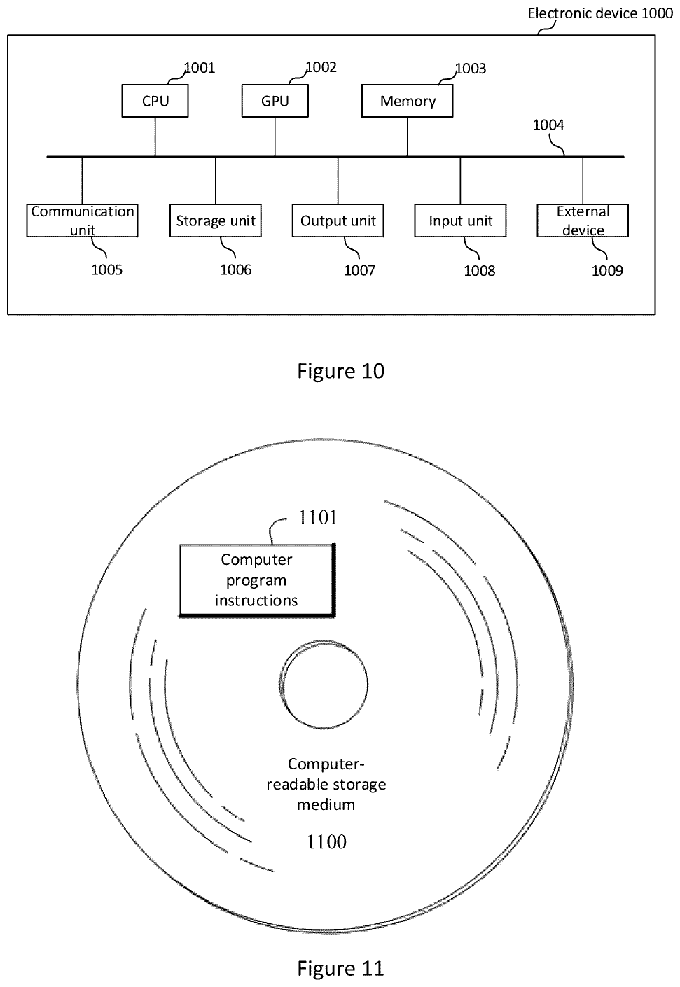

FIG. 10 is a hardware block diagram illustrating an electronic device 1000 according to an embodiment of the present disclosure. An electronic device according to an embodiment of the present disclosure at least includes a processor; And a memory for storing computer program instructions. When computer program instructions are loaded and run by a processor, the processor executes the training method and image processing method of the neural network model as described above.

The electronic device 1000 shown in FIG. 10 specifically includes a central processing unit (CPU) 1001, a graphics processing unit (GPU) 1002, and a main memory 1003. These units are interconnected by a bus 1004. A central processing unit (CPU) 1001 and/or a graphics processing unit (GPU) 1002 can be used as the above-mentioned processor, and a main memory 1003 can be used as the above-mentioned memory for storing computer program instructions. In addition, the electronic device 1000 may further include a communication unit 1005, a storage unit 1006, an output unit 1007, an input unit 1008 and an external device 1006, which are also connected to the bus 1004.

FIG. 11 is a schematic diagram illustrating a computer-readable storage medium according to an embodiment of the present disclosure. As shown in FIG. 11, a computer-readable storage medium 1100 according to an embodiment of the present disclosure has computer program instructions 1101 stored thereon. When the computer program instructions 1101 are executed by a processor, the training method and the image processing method of the neural network model according to the embodiment of the present disclosure described with reference to the above drawings are executed. The computer-readable storage medium includes, but is not limited to, for example, volatile memory and/or nonvolatile memory. The volatile memory may include, for example, a random access memory (RAM) and/or a cache and the like. The nonvolatile memory may include, for example, a read-only memory (ROM), a hard disk, a flash memory, an optical disk, a magnetic disk, and the like.

Above, the test question generating method, test question generating apparatus, test question generating system, using method of test question generating system, electronic device, computer-readable storage medium and computer program product according to the embodiment of the present disclosure are described with reference to the attached drawings, so that a single test question or a complete set of test paper satisfying different test forms can be provided for users with the minimum unit of knowledge involved in the problem solving step without a test question bank, and the difficulty, type and quantity of test questions can be flexibly configured according to the needs of users; In addition, the reform of teaching and assessment at any time requires providing the latest time-sensitive test questions, and updating relevant information and data according to the user's answer, so as to provide more accurate follow-up service.

One of ordinary skill in the art can realize that the units and algorithm steps of various examples described in connection with the embodiments disclosed herein can be implemented in electronic hardware, or a combination of computer software and electronic hardware. Whether these functions are implemented in hardware or software depends on the specific application and design constraints of the technical scheme. Skilled people can use different methods to realize the described functions for each specific application, but this implementation should not be considered beyond the scope of the present invention.

The basic principles of this disclosure have been described above in combination with specific embodiments. However, it should be pointed out that the advantages, advantages, effects, etc. mentioned in this disclosure are only examples rather than limitations, and these advantages, advantages, effects, etc. cannot be considered as necessary for each embodiment of this disclosure. In addition, the specific details disclosed above are only for the purpose of illustration and easy understanding, but not for limitation, and the above details do not limit that the disclosure must be realized with the above specific details.

The block diagrams of devices, devices, equipment and systems involved in this disclosure are only illustrative examples and are not intended to require or imply that they must be connected, arranged and configured in the manner shown in the block diagram. As those skilled in the art will recognize, these devices, devices, devices and systems can be connected, arranged and configured in any way. Words such as “including”, “containing”, “having” and so on are open words, which mean “including but not limited to” and can be used interchangeably with them. The terms “or” and “and” as used herein refer to the terms “and/or” and can be used interchangeably with them unless the context clearly indicates otherwise. The word “such as” used here refers to the phrase “such as but not limited to” and can be used interchangeably with it.

In addition, as used herein, the “or” used in the enumeration of items starting with “at least one” indicates a separate enumeration, so that, for example, the enumeration of “at least one of A, B or C” means A or B or C, or AB or AC or BC, or ABC (i.e. A and B and C). Furthermore, the word “exemplary” does not mean that the described example is preferred or better than other examples.

It should also be pointed out that in the system and method of the present disclosure, components or steps can be decomposed and/or recombined. These decomposition and/or recombination should be regarded as equivalent schemes of the present disclosure.

Various changes, substitutions and modifications to the techniques described herein may be made without departing from the taught techniques defined by the appended claims. In addition, the scope of the claims of the present disclosure is not limited to the specific aspects of the above-mentioned processes, machines, manufacturing, composition of events, means, methods and actions. Existing or later-to-be-developed processes, machines, manufactures, compositions, means, methods or actions that perform substantially the same functions or achieve substantially the same results as the corresponding aspects described herein may be utilized. Accordingly, the appended claims include such processes, machines, manufacture, compositions, means, methods or acts of events within their scope.

The above description of the disclosed aspects is provided to enable any person skilled in the art to make or use the present disclosure. Various modifications to these aspects will be obvious to those skilled in the art, and the general principles defined herein can be applied to other aspects without departing from the scope of this disclosure. Therefore, the present disclosure is not intended to be limited to the aspects shown herein, but is to be accorded the widest scope consistent with the principles and novel features disclosed herein.

The foregoing description has been presented for purposes of illustration and description. Furthermore, this description is not intended to limit the embodiments of the present disclosure to the forms disclosed herein. Although several example aspects and embodiments have been discussed above, those skilled in the art will recognize certain variations, modifications, changes, additions and sub-combination thereof.

1. A method for generating test question without question bank, comprising:
a preset condition receiving step for receiving a preset condition;
an initial element generating step for generating an initial element of a test question based on at least one preset database according to the preset condition;
an intermediate element generating step for generating an intermediate element of the test question based on the initial element of the test question and the at least one preset database according to the preset condition;
a test question judging step for judging whether the test question composed of the initial element and the intermediate element meets the preset condition,
when the test question does not meet the preset condition, returning to the initial element generating step or the intermediate element generating step,
when the test question meets the preset condition, the test question is generated based on the initial element and the intermediate element,
wherein one of the initial element and the intermediate element generated by last execution of the intermediate element generating step is used for generating an answer of the test question, and the other is used for generating a question of the test question.

2. The method for generating test question according to claim 1, wherein the intermediate elements other than the intermediate element generated by the last execution of the test question intermediate element generating step correspond to test question answer steps.

3. The method for generating test question according to claim 1, wherein the at least one preset database comprises a knowledge base database, an examination information database, a user group pattern database, and a user history database.

4. The method for generating test question according to claim 3, wherein the knowledge base database is used for storing information related to the knowledge to be examined, including one or more of basic knowledge information, common sense information, problem-solving idea information, problem-solving method information and error-prone point information.

5. The method for generating test question according to claim 3, wherein the test information base is used for storing information related to examinations, including one or more of examination paper structure information, question type information, difficulty distribution information, examination time information and test style information.

6. The method for generating test question according to claim 3, wherein the user group pattern database is used for storing information related to the user group, and the information related to the user group is obtained based on usage records of the user group, including one or more of problem-solving speed information, error-prone knowledge point information, problem-solving habit information and psychological acceptance limit information of a specific user group.

7. The method for generating test question according to claim 3, wherein the user history database is used for storing information related to a specific user, including one or more of answer history information, knowledge mastery information and learning progress information of the specific user.

8. The method for generating test question according to claim 1, wherein the preset condition includes one or more of a question type constraint condition, an examination content constraint condition and an examination style constraint condition.

9. The method for generating test question according to claim 1, wherein when the test question meets the preset condition, generating the test question based on the initial element of the test question and the intermediate element of the test question further comprises:
generating additional element according to the constraint conditions in the preset condition; and
combining the initial element, the intermediate element and the additional element of the test question to generate the test question satisfying the constraint conditions of the test question.

10. The method for generating test question according to claim 1, wherein the initial element generating step comprises:
determining that test points base on the knowledge base database, the user history database and/or the user group pattern database.

11. The method for generating test question according to claim 1, wherein the intermediate element generating step comprises:
determine a problem solving idea base on the initial element of the test question and the at least one preset database.

12. The method for generating test question according to claim 1, further comprising:
a test paper generating step for repeatedly executing the initial element generating step, the intermediate element generating step, the test question judging step and the test question generating step to generate a plurality of test questions;
a test paper judging step for judging whether the plurality of test questions meet the preset condition,
when the plurality of test questions do not meet the preset condition, returning to the test paper generating step to regenerate one or more of the plurality of test questions,
when the plurality of test questions meet the preset condition, proceed to a whole test paper generating step to generate a test paper based on the plurality of test questions.

13. The method for generating test question according to claim 12, wherein the test paper judging step comprises:
generating whole test paper constraint parameters based on the preset condition, wherein the whole test paper constraint parameters comprise one or more of a whole test paper question type parameter, a single question parameter of each test question, an associated parameter of each test question in the whole test paper, a generation time parameter, a maximum permissible error parameter and an answer time parameter;
judging whether the plurality of test questions meet the whole test paper constraint parameters.

14. The method for generating test question according to claim 13, wherein when the plurality of test questions do not meet the preset condition, returning to the test question generating step to regenerate one or more of the plurality of test questions comprises:
dynamically adjusting the whole test paper constraint parameters, and returning to the test paper generating step to regenerate one or more of the plurality of test questions.

15. The method for generating test question according to claim 14, wherein the generation error of one or more of the plurality of test questions is less than a predetermined threshold.

16. The method for generating test question according to claim 1, wherein the initial element and the intermediate element respectively have corresponding first parameter range interval,
and the initial element and the intermediate element generated after returning to the initial element generating step respectively have corresponding second parameter range interval,
the second parameter range interval is smaller than the first parameter range interval.

17. The method for generating test question according to claim 1, wherein the at least one preset database does not contain the answer of the test question and the question of the test question.

18. An apparatus for generating test question without question bank, comprising:
a preset condition receiving unit configured to receive a preset condition;
an initial element generating unit configured to generate an initial element of the test question based on at least one preset database according to the preset condition;
an intermediate element generating unit configured to generate an intermediate element of the test question based on the initial element and the at least one preset database according to the preset condition;
a test question judging unit configured to judge whether the test question composed of the initial element and the intermediate element meets the preset condition,
a test question generating unit configured to generate the test question based on the initial element and the intermediate element,
wherein, when the test question does not meet the preset condition, the test question initial element generating unit is configured to regenerate the initial element or the intermediate element generating unit is configured to regenerate the intermediate element,
when the test question meets the preset condition, the test question is generated by the test question generating unit based on the initial element and the intermediate element,
wherein one of the initial element and the intermediate element generated by the intermediate element generating unit for the last time is used for generating an answer of the test question, and the other of the two is used for generating a question of the test question.

19. The apparatus for generating test question according to claim 18, wherein the at least one preset database does not contain the answer of the test question and the question of the test question.

20. A method for using a test question generating system, comprising:
a preset condition receiving step for receiving a preset condition;
a test question and test paper generating step for generating test question and/or test paper;
an answer result receiving step for receiving answer result of the test question and/or test paper answered by users;
an answer result recording step for recording the answer result by taking answer step as a unit; and
a database updating step for updating the at least one preset database based on the answer result,
wherein test question and test paper generating step comprises
an initial element generating step for generating an initial element of a test question based on at least one preset database according to the preset condition;
an intermediate element generating step for generating an intermediate element of the test question based on the initial element of the test question and the at least one preset database according to the preset condition;
a test question judging step for judging whether the test question composed of the initial element and the intermediate element meets the preset condition,
when the test question does not meet the preset condition, returning to the initial element generating step or the intermediate element generating step,
when the test question meets the preset condition, the test question is generated based on the initial element and the intermediate element,
wherein one of the initial element and the intermediate element generated by last execution of the intermediate element generating step is used for generating an answer of the test question, and the other is used for generating a question of the test question.
